(19) United States
(12) Patent Application Publication
(10) Pub. No.: US 2004/0121826 A1
(43) Pub. Date: Jun. 24, 2004

(54) Rotating shaft of a rotary-Wing type digital mobile communication equipment and a method of mounting the same

(76) Inventors: Yawei Ma, Chao Yang District (CN); Kejiao Luo, Chao Yang District (CN); Zhengfeng Yang, Chao Yang District (CN)

Correspondence Address: A. Blair Hughes, McDonnell Boehnen Hulbert & Berghoff, 32nd Floor, 300 S. Wacker Drive, Chicago, IL, 60606, US

(21) Appl. No.: 10/642,408

(22) Filed: Aug. 15, 2003

(30) Foreign Application Priority Data
Dec. 24, 2002 (CN) 02157090.6

(51) Int. Cl. H04M 1/00; H04B 1/38

(52) U.S. Cl. 455/575.4; 455/566

(57) ABSTRACT

The present invention discloses a rotating shaft for pivotally connecting the rotary wing to the body of a rotary-wing type digital mobile communication equipment, wherein the rotating shaft comprises: a spindle formed at both ends thereof with a first positioning portion and at mid-section thereof with a rotary portion; a fixing member hitched on the first positioning portion of the spindle and to be positioned to the spindle fixedly and formed with a limit block; a rotary member pivotally disposed on the rotary portion of the spindle; a rotatable limit component pivotally disposed on the rotary portion of the spindle and positioned between the fixing member and the rotary member and provided with a radially protruding first protruding block; the rotary member is connected to the rotatable limit component and leaves some rotating space, when the rotary member rotates, it drives the rotatable limit component rotating, and when the first protruding block formed on the rotatable limit component is blocked by the limit block formed on the fixing member, the rotary member has rotated through 180 degrees.

### FIELD OF THE INVENTION

The present invention relates to a structural connecting piece of a digital mobile communication equipment, and more particularly, to a rotating shaft and a method of mounting the same, in use for pivotally connecting the rotary wing to the body of a rotary-wing type digital mobile communication equipment such as mobile telephone, PDA or the like.

### BACKGROUND OF THE INVENTION

With the development of technology and the improvement of living standard, digital mobile communication equipments such as mobile telephones, PDAs or the like for personal consumption have gradually entered the people's daily life. At the same time, to attract the consumer, the shape and the function of these digital mobile communication equipments are in succession got rid of the stale and brought forth the fresh, by example of mobile telephone, there are primitive type, up-flip type and down-flip type or the like, too many things to see. Recently, a rotary-wing type mobile telephone has appeared in the market, as shown in FIGS. 1 and 2, a rotary wing 2′ is pivotally disposed on a body 3′ of mobile telephone by a rotating shaft 1′ and rotates about the rotating shaft 1′ freely, to provide an completely new operation mode for user.

The existing rotary-wing type mobile telephone merely forms on the rotary wing 2′ with telephone receiver, the rotary wing is light and the its rotating shaft can only provide the function of rotating and transmitting sound signal by way of contact, so the existing rotating shaft can only achieve simple rotating connection function and rotate freely at arbitrary angle, without any fear of disturbance in the rear. However, with the developing trend of the mobile telephone being smaller and smaller, so much space provided on the rotary wing brings extremely large waste, because any other electronic device can't be disposed on it, the manufacturers then attempt to dispose LCD or the like on the rotary wing, at this time, the simple contact connection can't meet the need of transmitting a lot of signal, it certainly needs to make the communicating cable pass through the rotating shaft, thus, if the rotary wing still rotates arbitrarily, the connecting cable will be twisted seriously, as a result, the life of the communicating cable is reduced and even to be twisted off, for this reason, it needs to develop a new type rotating shaft which can cause the rotation movement of the rotary wing of the mobile telephone to be limited within a certain range and self-locked in an opening position.

As described above, there are some inconvenience and defects in the existing rotary-wing type mobile telephone, which expected to be improved on.

### SUMMARY OF THE INVENTION

Accordingly, it is a main object of the present invention to provide a rotating shaft of a digital mobile communication equipment and a method of mounting the same, which can enable the rotary wing to rotate clockwise or counterclockwise exactly within 180 degrees and return merely along the original path, to prevent the cable which passes through the rotating shaft from being twisted off.

It is another object of the present invention to provide a rotating shaft of a rotary-wing type digital mobile communication equipment and a method of mounting the same, when the rotary wing rotates clockwise or counterclockwise to an opening position, it can be self-locked in the opening position.

To achieve the above objects, the present invention provides a rotating shaft for pivotally connecting the rotary wing to the body of a rotary-wing type digital mobile communication equipment, wherein the rotating shaft comprises:

a spindle formed at both ends thereof with a first positioning portion and at mid-section thereof with a rotary portion;

a fixing member hitched on the first positioning portion of the spindle to be positioned to the spindle fixedly and formed with a limit block;

a rotary member pivotally disposed on the rotary portion of the spindle;

a rotatable limit component pivotally disposed on the rotary portion of the spindle and positioned between the fixing member and the rotary member and provided with a radially protruding first protruding block;

the rotary member is connected to the rotatable limit component and leaves some rotating space, when the rotary member rotates, it drives the rotatable limit component rotating, and when the first protruding block formed on the rotatable limit component is blocked by the limit block formed on the fixing member, the rotary member has rotated through 180 degrees.

A rotating shaft as described above, wherein, the rotatable limit component is ring-shaped, the rotary member is formed at an end surface thereof adjacent to the rotatable limit component with an axially extending ring-shaped protrusion which is provided with an opening, the first protruding block of the rotatable limit component is embedded in the opening whose width is larger than that of the first protruding block; when the rotary member rotates about the spindle, the ring-shaped protrusion comes into contact with the protruding block to drive the rotatable limit component rotating.

A rotating shaft as described above, wherein, the rotatable limit component in turn comprises a first rotary member, a rotatable limit member and a second rotary member; the second rotary member is fixedly connected to the rotary member and formed at the interior circumference thereof with a plurality of first open slots; the first protruding block is formed on the rotatable limit member which is formed at the interior circumference thereof with a plurality of second open slots in correspondence with the locations of the first open slots; the first rotary member is provided with a plurality of axially extending third protruding blocks which are inserted into the first open slots formed on the second rotary member through the second open slots formed on the rotatable limit member; the circumferential width of the second open slots is larger than that of the third protruding blocks; when the rotary member rotates, it drives the first rotary member and the second rotary member rotating and simultaneously drives the rotatable limit member rotating.

A rotating shaft as described above, wherein, the second rotary member is formed thereon with a plurality of second protruding blocks and the rotary member is correspondingly formed with a plurality of slots, the second protruding blocks are inserted into the slots, so that the second rotary member is fixedly connected to the rotary member.

A rotating shaft as described above, wherein, the second rotary member is formed thereon with a plurality of slots and the rotary member is correspondingly formed with a plurality of second protruding blocks, the second protruding blocks are inserted into the slots, so that the second rotary member is fixedly connected to the rotary member.

A rotating shaft as described above, wherein, the rotating shaft further comprises a self-locked positioning member and two elastic slices covered each other, the mid-section of the spindle is also formed with a second positioning portion, the self-locked positioning member and the two elastic slices are in turn formed at one side of the rotary member away from the fixing member and hitched on the second positioning portion of the spindle to be positioned to the spindle fixedly; the self-locked positioning member is disposed at one side opposite to the rotary member with two protrusions which are radially symmetrically arranged at 180 degrees, the corresponding side of the rotary member is formed with two grooves corresponding to the two projections.

A rotating shaft as described above, wherein, the rotary member further comprises an cap formed at the other side opposite to the fixing member and fixedly hitched on the first positioning portion of the spindle.

A rotating shaft as described above, wherein, the first positioning portion formed on the spindle is a polygonal-sectional protrusion, the center holes of the fixing member and the cap are disposed with corresponding polygonal holes.

A rotating shaft as described above, wherein, the second positioning portion of the spindle are two plane portions, the center holes of the self-locked positioning member and the two elastic slices are disposed with corresponding linear edge.

A rotating shaft as described above, wherein, the spindle is hollow, through which passes an electrical connecting cable or a flexible printing plate disposed between the rotary wing and the body.

A rotating shaft as described above, wherein, the fixing member and the rotary member are both formed with a plurality of screw holes.

The present invention also provides a method of mounting the rotating shaft as described above between the mobile telephone body and the rotary wing, wherein comprises following steps:

to provide a rotating shaft assembly assembled with a plurality of members;

to provide a mobile telephone body, on the upper end of the front shell of the body is formed with a sunken mounting-space;

to place the rotating shaft into the mounting-space of the front shell of the mobile telephone body, and to fixedly mount the rotary member of the rotating shaft inside the front shell of the mobile telephone body;

to provide a rotary wing of the mobile telephone;

to fixedly mount together the back shell of the rotary wing of the mobile telephone and the fixing member of the rotating shaft.

A method of mounting the rotating shaft between the mobile telephone body and the rotary wing as described above, wherein, there is provided with a first acute angle between the centerline of the mounting-space formed on the front shell of the mobile telephone body and the horizontal datum plane of the front shell of the mobile telephone body, and the mounting angle formed between the back shell of the rotary wing and the rotating shaft is set a second acute angle, the first acute angle and the second acute angle are the complementary angles to each other.

A method of mounting the rotating shaft between the mobile telephone body and the rotary wing as described above, wherein, the depth of the mounting-space of the body front shell is in correspondence with the height of the rotating shaft, so that the rotating shaft is aligned with the body front shell when the rotating shaft is disposed in the mounting-base.

The present invention brings such advantages that, because the rotating shaft of the digital mobile communication equipment according to the present invention is provided with a rotatable limit component, when the rotary member rotates, it drives the rotatable limit component rotating, since the rotatable limit component is not absolutely secured to the rotary member but leaves some space, the rotary member does not drive the rotatable limit component rotating till it has idly rotated for a certain distance, thereby when the rotary member rotates clockwise and counterclockwise, it will not stop until it has rotated 180 degrees so as to achieve bi-directional equiangular rotation.

Since the rotating shaft of the present invention is provided with a self-locked mechanism which is in a state of being self-locked while the mobile telephone is closed or rotated to be open completely, and is convenient for user to operate and provides a certain safety, the self-locked mechanism will not be unlocked until a certain rotating force is applied to the rotary wing of the mobile telephone, so as to prevent the mobile telephone from undesirably sliding out of the rotary wing.

Now, the present invention will be described with reference to the accompanying drawings and specific embodiments.

### BRIEF DESCRIPTION OF THE DRAWING

FIG. 1 is a view for illustrating a rotary-wing type mobile telephone in a state of use according to the prior art;

FIG. 2 is a view for illustrating a rotary-wing type mobile telephone according to the prior art, with a rotary wing in an opening position;

FIG. 3A is an assembly constitutional diagram of a rotating shaft according to a first embodiment of the present invention;

FIG. 3B is a schematic diagram for illustrating the center of the rotating shaft passing through a communication cable according to the present invention;

FIGS. 4A, 4B and 4C are schematic diagrams for illustrating the rotating shaft during operated according to the first embodiment of the present invention;

FIG. 5 is an exploded constitutional diagram for illustrating a rotating shaft according to a second embodiment of the present invention;

FIG. 6A is a schematic diagram for illustrating the rotating shaft in the locked position according to the second embodiment of the present invention;

FIG. 6B is a schematic diagram for illustrating the rotating shaft in the unlocked position according to the second embodiment of the present invention;

FIG. 7A is an entirety schematic diagram for illustrating the rotating shaft during assembled according to the present invention;

FIGS. 7B, 7C, 7D and 7E are schematic diagrams for illustrating the mounting ways of the rotating shaft according to the present invention;

FIG. 7F is a cross-sectional view for illustrating the rotating shaft fully mounted inside the mobile telephone according to the present invention.

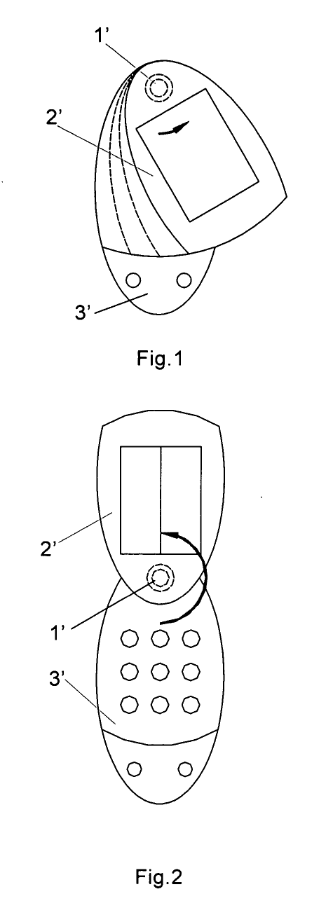

### DETAILED DESCRIPTION OF THE PREFERRED EMBODIMENT

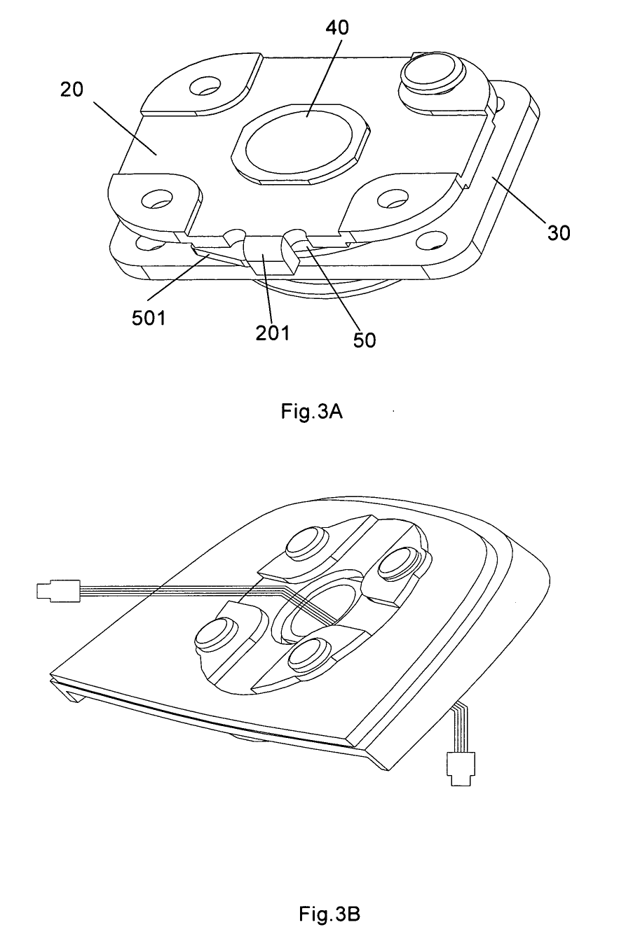

As shown in FIG. 3A, it is a constructional drawing for illustrating a rotating shaft according to a first embodiment of the present invention. The rotating shaft of the present invention includes a fixing member 20, a rotary member 30 and a hollow spindle 40 thereof. The fixing member 20 and the spindle 40 is oppositely fixedly connected together, This can be such achieved that one end of the spindle 40 is designed to be a polygonal positioning portion, and the center of the fixing member 20 is also designed to be a positioning portion for corresponding polygonal hole, then they are locked each other. The rotary member 30 is pivotally disposed on the spindle 40 and can be rotated about the spindle 40. The fixing member 20 and the rotary member 30 are both provided with mounting surface and may be via screws connected to the body and the rotary wing of a mobile telephone respectively.

In order to limit the rotary member 30 while rotating 180 degrees, according to the present embodiment, a limit block 201 is protrusively disposed on the other side of the mounting surface of the fixing member 20. And, in order to cause the rotary member 30 to be blocked by the limit block 201 when rotating 180 degrees clockwise or counterclockwise, the rotating shaft of the present invention further includes a rotatable limit component 50, which is also disposed on the spindle 40 and rotates about the spindle 40 in response to the rotation of the rotary member 30. The rotatable limit component 50 is disposed at the circumferential outside thereof with a first protruding block 501, and a ring-shaped protrusion 301 extends axially outwards from the inside of the rotary member 30, which is formed with an opening 302 having a specified width larger than that of the first protruding block 501. The first protruding block 501 of the rotatable limit component 50 is embedded into the opening 302 and leaves some space, when the rotary member 30 rotates about the spindle 40, the protrusion 301 drives the rotatable limit component 50 rotating together via the opening 302.

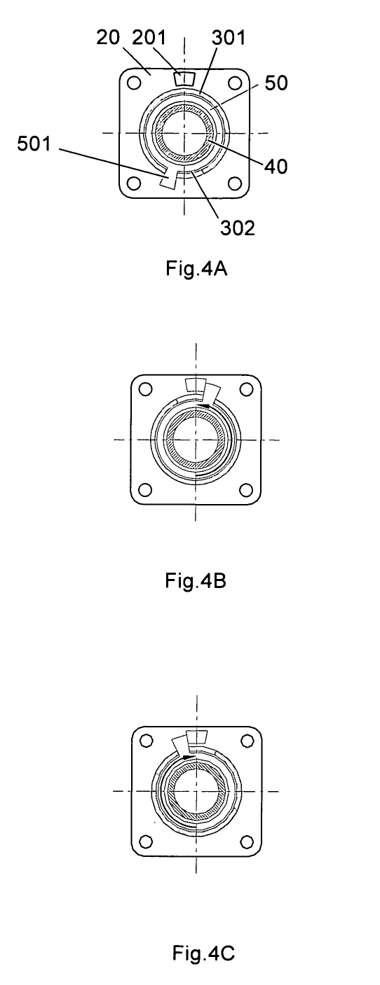

As shown in FIG. 4B, when the rotary member 30 rotates counterclockwise with the rotatable limit component 50 being rotated together, if the first protruding block 501 of the rotatable limit component 50 is blocked by the limit block 201 formed on the fixing member 20, the rotary member 30 exactly rotates 180 degrees, at this time, the rotary member 30 can merely return clockwise along the original path. As shown in FIG. 4A, because the width of the opening 302 is larger than that of the first protruding block 501, when the rotary member 30 rotates clockwise, the rotary member 30 does not drive the rotatable limit component 50 at once, but rotates itself firstly, and does not start to drive the rotatable limit component 50 rotating until it rotates to one side of the opening 32 to contact the first protruding block 501, as shown in FIG. 4C. When they are rotated together till the protruding block 501 is blocked by the limit block 201, the rotary member 30 has exactly rotated through 180 degrees, at this time, the rotary member 30 still can merely returns along the original path. It is known from the above description, the construction of the rotating shaft of the present invention allow the rotary member 30 to rotate 180 degrees clockwise or counterclockwise and also return merely along the original path, to prevent the cable or the flexible printing plate (as shown in FIG. 3B) in the rotating shaft from being overly twisted. In this embodiment, since the limit block 201 and the first protruding block 501 both have a certain width, the width of the opening 302 formed on the rotary member 30 must be larger than that of the first protruding block 501, and the practical value is determined in accordance with the width of the limit block 201 and the first protruding block 501. Thus, it can cause the rotary member 30 and the limit component 50 to be rotated oppositely, and finally ensure that the rotary member 30 would not be blocked by the limit block 201 until it has rotated 180 degrees when rotates clockwise and counterclockwise.

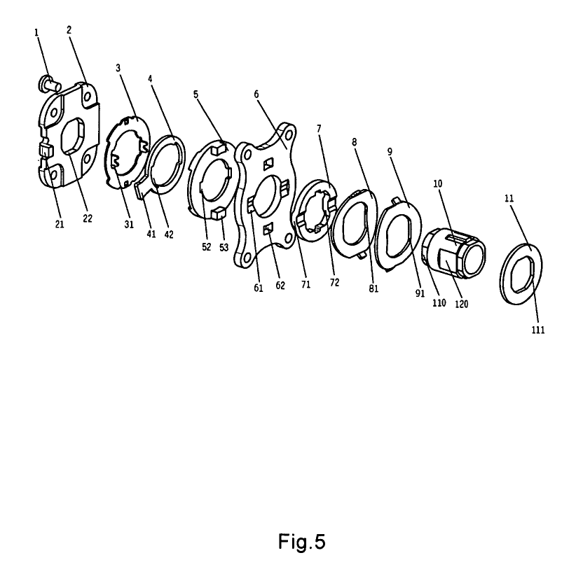

FIG. 5 is an exploded constitutional diagram for illustrating a rotating shaft according to a second embodiment of the present invention. Compared to the first embodiment, the second embodiment also includes a rotary member 6 pivotally disposed on the spindle 10, a hollow spindle 10, which is formed at both ends thereof with polygonal positioning portions 110, and fixing member 2 formed with a corresponding polygonal positioning hole 22 and a limit block 21 and fixed to one end of the spindle 10 by the positioning hole 22 so as to be positioned to the spindle fixedly, The rotatable limit component of the second embodiment consists of three structural members, respectively, a first rotary member 3, a rotatable limit member 4 and a second rotary member 5, which are in turn hitched on the spindle 10 and can rotate about the spindle; where an end surface of the second rotary member 5 is formed at the external circumference thereof with a plurality of axially extending second protruding blocks 53, the corresponding position of the rotary member 6 is provided with a plurality of slots 62, the second protruding blocks 53 formed on the second rotary member 5 are inserted into the slots 62 disposed on the rotary member 6 so as to cause the second rotary member 5 to rotate in response to the rotation of the rotary member 6; the rotatable limit member 4 is radially formed with a first protruding block 41 and formed at the interior circumference thereof with a plurality of second open slots 42; the first rotary member 3 is formed at the interior circumference thereof with a plurality of axially extending third protruding blocks 31, protruding blocks 31 are respectively inserted into a plurality of a first open slots 52 formed on the interior circumference of the second rotary member 5 through a plurality of the second open slots 42 on the limit member 4; whereby, the first rotary member 3 and the rotatable limit member 4 can also be rotated about the spindle 10 in response to the rotation of the second rotary member 5.

Similar to the first embodiment, since the second protruding blocks 53 are tightly inserted into the slots 62 of the rotary member 6, when the rotary member 6 rotates, it drives the second rotary member 5 rotating at once, at the same time, since the third protruding blocks 31 are tightly inserted into the first open slots 52, the rotary member 3 is therefore also driven to rotate at once. For the same reason as the first embodiment, the arc width of the second open slots 42 should be larger than that of the third protruding block 31, so that the first rotary member 3 and the second rotary member 5 take a idle travel first, then drive the rotatable limit member 4 to rotate. When the first protruding block 41 formed on the rotatable limit member 4 comes into contact with the limit block 21 formed on the fixing member 2, the rotary member 6 rotates 180 degrees relative to the fixing member 2, then return merely along the original path. Apparent from the drawing, in the second embodiment, it also allow the rotary member 6 to rotate 180 degrees clockwise or counterclockwise and return along the original path. Naturally, in order to cause the rotating angle to be accurately controlled at the point of 180 degrees when rotated clockwise and counterclockwise so as to be limited, the circumference width of the second open slot 42 should be correspond with those of the limit block 21, the first protruding block 41 and the third protruding block 31.

As shown in FIG. 5, in order to be locked after having rotated 180 degrees, the second embodiment of the present invention is provided with a self-locked mechanism which comprises a self-locked positioning member 7 and two elastic slices 8, 9 covered each other, they are in turn hitched on the spindle 10 on which the matching surfaces are a plurality of planes 120, the interior circumferences of the self-locked positioning member 7 and the two elastic slices 8, 9 are respectively formed with corresponding straight segments 72,81 and 91 which are matched with the planes 120 formed on the spindle so that the self-locked mechanism is fixed to the spindle oppositely.

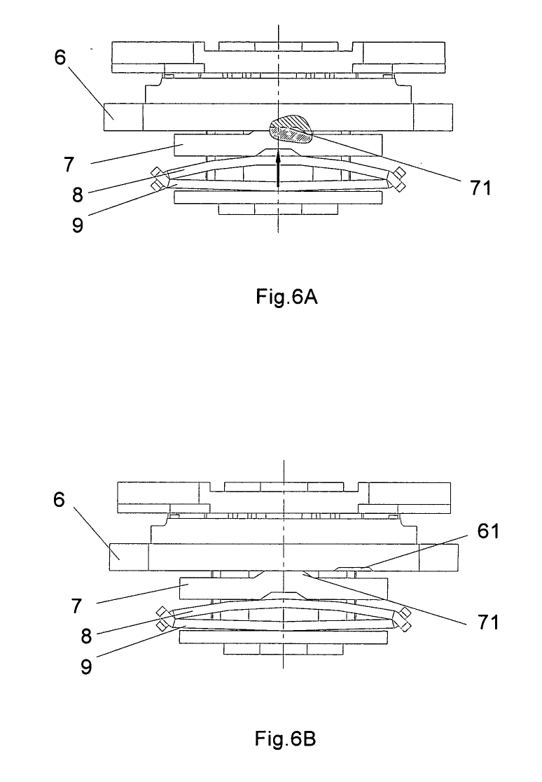

The self-locked positioning member 7 is formed at its one end surface facing towards the rotary member 6 with two axial protrusions 71 which are radially symmetrically arranged at 180 degrees, and the rotary member 6 is formed with two corresponding grooves 61; As shown in FIG. 6A, the shapes of the grooves 61 are matched with that of the protrusions 71, as the rotary wing connected to the rotary member 6 is closed relative to the body, the two protrusions 71 are rightly disposed inside the two grooves 61 of the rotary member 6, respectively. Because the elastic slices 8,9 apply a certain pre-pressure when mounted, the elastic slices then apply a certain pressure to the matching construction all the times, so in the case of no external force, the protrusions 71 may not slide out of the grooves 61 so as to be self-locked; As FIG. 6B illustrated, only if the rotary member 6 is rotated with a certain pressure, the protrusions 71 could slide out of the grooves 61 to cause the rotary member 6 to start to rotate. After the rotary member 6 has rotated 180 degrees, due to the symmetry, the two protrusions 71 herein slide into the grooves 61 so as to be similarly self-locked.

As shown in FIG. 5, in order to mount the rotating shaft conveniently, the other end of the rotating shaft is also mounted with a cap 11 inside which positioning polygon 111 is firmly matched with the polygonal positioning portion 110 of the spindle.

The rotating shaft of the present invention is used for pivotally connecting to rotary-wing type mobile communication equipment, by example of mobile telephone, the method of mounting the rotating shaft between the mobile telephone body and the rotary wing will be described. Actually, in the present invention, the rotary member 6 of the rotating shaft is positioned opposite to the fixing member 2, that is, while the rotary member 6 is fixed, the fixing member 2 rotates, thus it can be seen that the method of mounting the rotating shaft can be flexibly changed according to practical situations.

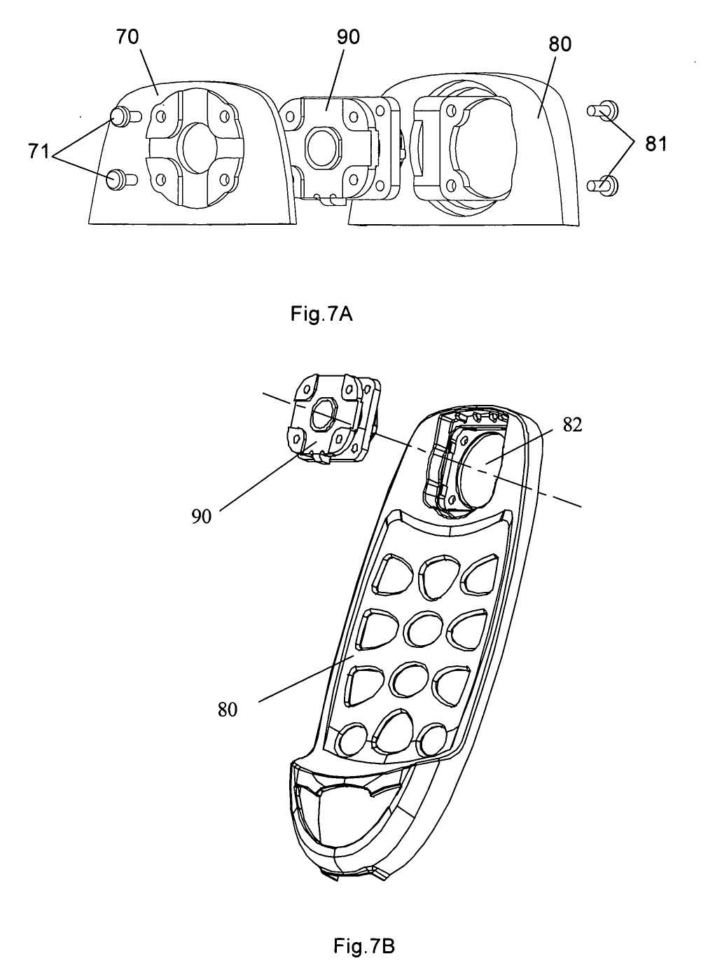

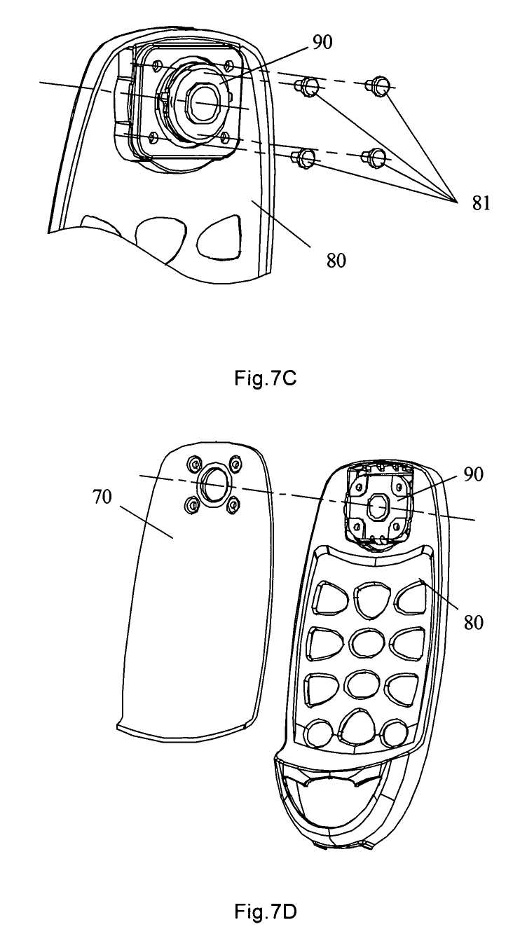

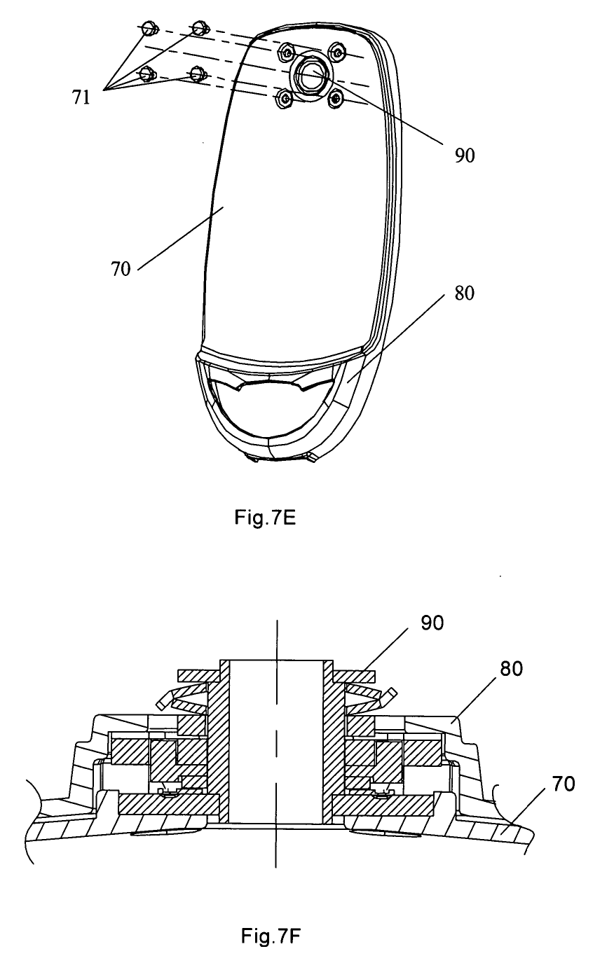

FIG. 7A is a constructional schematic diagram for illustrating the rotating shaft 90 mounted between the rotary wing 70 and the body 80 of the mobile telephone according to the present invention, As can be seen from the drawing, in the present method of mounting, the fixing member of the rotating shaft 90 is mounted on the rotary wing 70 by a set of screws 71, and the rotary member of the rotating shaft 90 is mounted on the mobile telephone body 80 by another set of screws 81. The mounting process comprises following steps:

1. As shown in FIG. 7B, firstly to provide a front shell 80 of the mobile telephone body, on which upper end is formed with a sunken mounting-base 82;

2. As shown in FIG. 7C, to place the rotating shaft 90 into the mounting-base 82 and fix the rotary member 6 of the rotating shaft inside the front shell 80 of the mobile telephone body via a plurality of screws 81;

3. As shown in FIG. 7D, to provide a back shell 70 of the rotary wing of the mobile telephone, which is provided with through holes corresponding to the mounting holes of the rotating shaft;

4. As shown in FIG. 7E, to secure the back shell 70 of the rotary wing of the mobile telephone to the fixing member 2 of the rotating shaft 90 via a plurality of screws 71, so as to finish mounting.

FIG. 7F is a constructional cross-sectional diagram for illustrating the rotating shaft having been mounted according to the mounting method provided by the present invention, as seen from the drawing, the rotating shaft 90 is completely laid inside the mobile telephone body, both beautiful and dustproof.

In order to cause the rotary wing of the mobile telephone to be arranged at an angle rather than parallel to the mobile telephone body after being rotated to open, and also in order to be convenient for user, in this mounting method of the present invention, it can allow the rotating shaft 90 to be mounted at a slant angle rather than horizontally positioned, and an angle formed between the rotary wing and the rotating shaft 90 is adjusted to be a complementary angle to the slant angle of the rotating shaft, so that there will be a certain angle between the rotary wing and the mobile telephone body after the rotary wing rotates to open.

Since the rotating curved surface of the rotary wing is taper-shaped curved surface, it is required that the connection way between the rotary wing and the rotating shaft be surface contact. In order to cause the mounted rotary wing to be abutted against the mobile body firmly, the size of the mounting-base of the front shell of the body is corresponding to that of the rotating shaft, as the rotating shaft is disposed in the mounting-base, the rotating shaft is substantially aligned with the front shell of the body. Thus, when the rotary wing of the mobile telephone has been mounted, the taper-shaped curved surface can be rotated and abutted against the mobile telephone body firmly.

In the present invention, because the rotating shaft of the digital mobile communication equipment is provided with a rotatable limit component, when the rotary member rotates, it drives the rotatable limit component rotating, since the rotatable limit component is not absolutely secured to the rotary member but leaves some space, the rotary member does not drive the rotatable limit component rotating till it has idly rotated for a certain distance, thereby when the rotary member rotates clockwise and counterclockwise, it will not stop until it has rotated 180 degrees so as to achieve bi-directional equiangular rotation.

Since the rotating shaft of the present invention is provided with a self-locked mechanism which is in a state of being self-locked while the mobile telephone is closed or rotated to be open completely, and is convenient for user to operate and provides a certain safety, the self-locked mechanism will not be unlocked until a certain rotating force is applied to the rotary wing of the mobile telephone, so as to prevent the mobile telephone from undesirably sliding out of the rotary wing.

While a few preferred embodiments of the present invention have been shown and described above, and it is not confined to the embodiments of the present invention, it will be obvious to those skilled in the art that equivalent constructional changes may be made according to the description and the drawings, without departing from the scope of the present invention.

What is claimed is:

1. A rotating shaft for pivotally connecting the rotary wing to the body of a rotary-wing type digital mobile communication equipment, wherein the rotating shaft comprises:
a spindle formed at both ends thereof with a first positioning portion and at mid-section thereof with a rotary portion;
a fixing member hitched on the first positioning portion of the spindle and to be positioned to the spindle fixedly and formed with a limit block;
a rotary member pivotally disposed on the rotary portion of the spindle;
a rotatable limit component pivotally disposed on the rotary portion of the spindle and positioned between the fixing member and the rotary member and provided with a radially protruding first protruding block;
the rotary member is coupled to the rotatable limit component and leaves some rotating space, when the rotary member rotates, it drives the rotatable limit component rotating, and when the first protruding block formed on the rotatable limit component is blocked by the limit block formed on the fixing member, the rotary member has rotated through 180 degrees.

2. A rotating shaft as claimed in claim 1, wherein the rotatable limit component is ring-shaped, the rotary member is formed at an end surface thereof adjacent to the rotatable limit component with an axially extending ring-shaped protrusion which is provided with an opening, the first protruding block of the rotatable limit component is embedded in the opening whose width is larger than that of the first protruding block; when the rotary member rotates about the spindle, the ring-shaped protrusion comes into contact with the protruding block to drive the rotatable limit component rotating.

3. A rotating shaft as claimed in claim 1, wherein the rotatable limit component in turn comprises a first rotary member, a rotatable limit member and a second rotary member; the second rotary member is fixedly connected to the rotary member and formed at the interior circumference thereof with a plurality of first open slots; the first protruding block is formed on the rotatable limit member which is formed at the interior circumference thereof with a plurality of second open slots in correspondence with the locations of the first open slots; the first rotary member is provided with a plurality of axially extending third protruding blocks which are inserted into the first open slots formed on the second rotary member through the second open slots formed on the rotatable limit member; the circumferential width of the second open slots is larger than that of the third protruding blocks; when the rotary member rotates, it drives the first rotary member and the second rotary member rotating and simultaneously drives the rotatable limit member rotating.

4. A rotating shaft as claimed in claim 3, wherein the second rotary member is formed thereon with a plurality of second protruding blocks and the rotary member is correspondingly formed with a plurality of slots, the second protruding blocks are inserted into the slots, so that the second rotary member is fixedly connected to the rotary member.

5. A rotating shaft as claimed in claim 3, wherein the second rotary member is formed thereon with a plurality of slots and the rotary member is correspondingly formed with a plurality of second protruding blocks, the second protruding blocks are inserted into the slots, so that the second rotary member is fixedly connected to the rotary member.

6. A rotating shaft as claimed in claim 3, wherein the rotating shaft further comprises a self-locked positioning member and two elastic slices covered each other, the mid-section of the spindle is also formed with a second positioning portion, the self-locked positioning member and the two elastic slices are in turn formed at one side of the rotary member away from the fixing member and hitched on the second positioning portion of the spindle and to be positioned to the spindle fixedly; the self-locked positioning member is formed at one side opposite to the rotary member with two protrusions which are radially symmetrically arranged at 180 degrees, the corresponding side of the rotary member is formed with two grooves corresponding to the two protrusions.

7. A rotating shaft as claimed in claim 6, wherein the rotary member further comprises an cap positioned at the other side opposite to the fixing member and fixedly hitched on the first positioning portion of the spindle.

8. A rotating shaft as claimed in claim 7, wherein the first positioning portion formed on the spindle is a polygonal-sectional protrusion, the center holes of the fixing member and the cap are disposed with corresponding polygonal holes.

9. A rotating shaft as claimed in claim 6, wherein the second positioning portion of the spindle are two plane portions, the center holes of the self-locked positioning member and the two elastic slices are formed with corresponding linear edge.

10. A rotating shaft as claimed in claim 1, wherein the spindle is hollow, through which passes an electrical connecting cable or a flexible printing plate disposed between the rotary wing and the body.

11. A rotating shaft as claimed in claim 1, wherein the fixing member and the rotary member are both formed with a plurality of screw holes.

12. A method of mounting the rotating shaft as claimed in claim 1 between the mobile telephone body and the rotary wing, wherein comprises following steps:
a. to provide a rotating shaft assembly assembled with a plurality of members;
b. to provide a mobile telephone body, on the upper end of the front shell of the body is formed with a sunken mounting-space;
c. to place the rotating shaft into the mounting-space of the front shell of the mobile telephone body, and to fixedly mount the rotary member of the rotating shaft inside the front shell of the mobile telephone body;
d. to provide a rotary wing of the mobile telephone;
e. to fixedly mount together the back shell of the rotary wing of the mobile telephone and the fixing member of the rotating shaft.

13. A method of mounting the rotating shaft between the mobile telephone body and the rotary wing as claimed in claim 12, wherein there is provided with a first acute angle between the centerline of the mounting-space formed on the front shell of the mobile telephone body and the horizontal datum plane of the front shell of the mobile telephone body, and the mounting angle formed between the back shell of the rotary wing and the rotating shaft is set a second acute angle, the first acute angle and the second acute angle are the complementary angles to each other.

14. A method of mounting the rotating shaft between the mobile telephone body and the rotary wing as claimed in claim 13, wherein the depth of the mounting-space of the body front shell is in correspondence with the height of the rotating shaft, so that the rotating shaft is aligned with the body front shell when the rotating shaft is disposed in the mounting-base.
